(19) United States
(12) Patent Application Publication
(10) Pub. No.: US 2026/0180180 A1
(43) Pub. Date: Jun. 25, 2026

(54) RFID DEVICES HAVING DIPOLE ANTENNAS

(71) Applicant: Avery Dennison Retail Information Services LLC, Mentor, OH (US)

(72) Inventors: Shubin MA, Tampere (FI); Elham MORADI, Tampere (FI); Antti T. LESKELÄ, Vesilahti (FI); Tanzeela MITHA, Azusa, CA (US); Muhammad RIZWAN, Chelmsford (GB)

(21) Appl. No.: 19/427,282

(22) Filed: Dec. 19, 2025

Related U.S. Application Data
(60) Provisional application No. 63/736,943, filed on Dec. 20, 2024.
(60) Provisional application No. 63/916,909, filed on Nov. 13, 2025.

(51) Int. Cl. H01Q 7/00; H01Q 1/22

(52) U.S. Cl. CPC H01Q 7/00; H01Q 1/2208

(57) ABSTRACT

The present disclosure provides a Radio Frequency Identification (RFID) device comprising an antenna formed from an electrically conductive material and comprising a loop segment and an emission segment and an integrated circuit (IC) operatively coupled to the loop segment. The antenna exhibits improved performance when the RFID device is placed on packages containing high-dielectric materials.

### CROSS REFERENCE TO RELATED APPLICATIONS

The present application claims priority to U.S. Provisional Application No. 63/916,909 filed on Nov. 13, 2025, and U.S. Provisional Application No. 63/736,943 filed on Dec. 20, 2024, the entire contents and disclosure of which is hereby incorporated by reference.

### FIELD OF INVENTION

The present disclosure relates to radio frequency identification (RFID) devices and, more particularly, to environmentally adaptable RFID devices designed for efficient operation when placed on or near high-dielectric, lossy materials.

### BACKGROUND

Radio Frequency Identification (RFID) technology has become increasingly important in various industries for tracking and managing products. RFID tags offer several benefits, including improved inventory control, reduced waste, and enhanced product tracking and traceability. However, the performance of RFID tags can be significantly affected by the materials to which they are attached or in close proximity. Lossy and high-dielectric materials are a particular challenge.

One such challenging application is in the food industry and involves using RFID tags with packaged meat or fish products. These products are electrically lossy and have a high-dielectric constant, κ. The dielectric constant of a material is the ratio of its permittivity to the permittivity of free space (referred to as “relative permittivity,” εᵣ). Both terms will be used interchangeably herein.

Typically, when a dipole antenna is placed near food proteins with relative permittivity values between 35 and 60, its impedance changes due to interactions with the surrounding medium. The antenna's electric field couples with the protein, and the high permittivity material slows the electromagnetic wave propagation. As a result, the effective wavelength shortens, causing the resonant frequency to shift downward. In other words, the dipole antenna resonates at a lower frequency than it would in free space, which adversely affects the RFID tag's ability to transmit a signal that can be successfully received by an accompanying RFID reader.

Another important effect is that the dipole demonstrates a reduction in radiation resistance when it is near high-permittivity materials. It is believed that this occurs because the dielectric absorbs some of the energy that would typically radiate into free space. Because proteins are both high in permittivity and lossy, they absorb additional energy and convert it into heat, further lowering the antenna's overall radiation efficiency. The challenges are further compounded in scenarios where RFID-tagged products are stacked or densely packed, such as in-store coolers or during transportation. In these situations, the presence of multiple layers of high-dielectric materials between the RFID tag and the reader can significantly attenuate the radio frequency signals, making it difficult to achieve consistent and reliable tag reads.

Additionally, the diverse nature of products in industries such as food retail presents varying dielectric environments. Different types of meats, produce, packaged goods, and other lossy, high-dielectric materials each present unique and specific challenges for RFID tag performance. For example, the high water content of meat absorbs radio waves, particularly in the ultra-high frequency (UHF) band in which RFID tags typically operate. The water in meat also contains salts, which increase the absorptive effect. In other cases, fat is less absorptive than muscle or salt water, so each type of meat (e.g., beef, pork, chicken, fish, etc.), as well as different cuts of each type of meat (e.g., filets, ground meat, etc.), will absorb UHF signals differently. In addition, chicken is often treated with a saltwater brine, making it a particularly challenging application for RFID tags. This variability necessitates RFID solutions that can adapt to a wide range of material properties and environmental conditions.

Furthermore, the physical constraints of product packaging and labeling often limit the size and placement options for RFID tags. This restriction makes it challenging to design antennas that are both compact enough to fit within the available space and efficient enough to perform well in high-dielectric environments.

As the adoption of RFID technology continues to grow across various industries, there is an increasing need for RFID tags that can maintain reliable performance when applied to or used in proximity to high-dielectric, lossy materials. Improved RFID tag designs that can overcome these challenges while remaining cost-effective and suitable for high-volume manufacturing are highly desirable.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In general the embodiments described herein relate to a RFID device having a dipole antenna. The configuration and construction of the antenna may be defined with parameters to provide improved total efficiency and radiation efficiency when the RFID device is placed on packages that are near or on high-dielectric materials. The antenna may be configured as a normal dipole antenna, folded dipole antenna, or modified versions of either antenna.

According to an aspect of the present disclosure, there is provided a RFID antenna comprising a loop segment having pads at each end configured to connect to an integrated circuit chip and one or more emission segments, each emission segment comprises a connection portion, folded portion, a longitudinal edge portion, and a line portion, where the line portions of each emission segments are joined, to define a perimeter of the RFID antenna. In one embodiment the following parameters are used to design the antenna including the antenna width ranges from 41 mm to 70 mm, the loop length of the loop segment ranges from 41 mm to 55 mm, an aspect ratio of the RFID antenna ranges from 1.3 to 3.4, and the perimeter ranges from 168 mm to 282 mm. Achieving these parameters allows the RFID antenna to have a total efficiency of at least 0.09% or more and IC impedance matching efficiency of at least 0.45 or more. In one embodiment, the joined line portions form a continuous loop from the one or more emission segments. In some embodiments, the one or more emission segments are a conductive trace having a width ranging from 0.3 mm to 3 mm. Preferably, the width of a conductive trace forming the longitudinal edge portion is equal to or less than the width of a conductive trace forming the folded portion.

According to an aspect of the present disclosure, there is provided a RFID integrated circuit chip and an antenna. The antenna comprises a loop segment having pads at each end configured to connect to an integrated circuit chip and one or more emission segments, each emission segment comprises a connection portion, folded portion, a longitudinal edge portion, and a line portion, where the line portions of each emission segments are joined, to define a perimeter of the RFID antenna. In one embodiment the following parameters are used to design the antenna including the antenna width ranging from 41 mm to 70 mm, the loop length of the loop segment ranging from 41 mm to 55 mm, an aspect ratio of the RFID antenna ranging from 1.3 to 3.4, and the perimeter ranging from 168 mm to 282 mm. Achieving these parameters allows the RFID antenna to have a total efficiency of at least 0.09% or more and IC impedance matching efficiency of at least 0.45 or more. In some embodiments, the RFID device may be applied to a label having at least one adhesive surface. The label or the RFID device itself may be applied to a package containing a high-dielectric material.

Some embodiments of a Radio Frequency Identification (RFID) device are provided herewith. The RFID device includes an antenna formed from an electrically conductive material and an impedance-matching loop operatively coupled to the antenna. The RFID device further includes an integrated circuit (IC) operatively coupled to the loop portion.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1A illustrates a conventional RFID device.

FIG. 1B illustrates a conventional RFID device and its radiation pattern.

FIG. 1C illustrates a conventional RFID device with a modified radiation pattern.

FIG. 2 illustrates a RFID device placed on a package containing a high-dielectric material according to aspects of the present disclosure.

FIGS. 3A-B illustrate a package having a RFID device according to aspects of the present disclosure.

FIGS. 3C-D illustrate stacked configurations of packages with a RFID device, according to aspects of the present disclosure.

FIGS. 4A-4F illustrate a RFID device having a normal dipole according to aspects of the present disclosure.

FIG. 5A-5H illustrate a RFID device having a folded dipole according to aspects of the present disclosure.

FIG. 6 illustrates a RFID device having a spacer according to aspects of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Radio Frequency Identification (RFID) technology has become increasingly important in various industries for tracking and managing products. However, conventional RFID tags may face challenges when used with lossy, high-dielectric materials, such as food products, liquids, or certain packaging materials. Exemplary high-dielectric materials may include proteins such as meat including but not limited to beef, chicken, turkey, pork, seafood, as well as other similar proteins. The high-electrical material is generally wrapped in a plastic film and carried on a foam tray. The relative permittivity of the plastic foam and foam tray is accounted for as part of the entire package. The RFID device may be attached to the plastic film. Without limitations, the high-dielectric materials may also include other proteins such as milk, yogurt, and eggs or egg products. The high-dielectric materials generally may have a relative permittivity (εᵣ) that is less than or equal to 60, e.g. less than or equal to 55 or less than or equal to 50. The relative permittivity (εᵣ) for high-dielectric materials should be higher than 5, e.g., preferably higher than 15 or more preferably higher than 20. The temperature of the package (frozen or thawed), moisture content, and fat percentage of the protein are all factors that can contribute to variations into the relative permittivity (εᵣ). The RFID devices described herein have improved adaptability to respond to variations across multiple types of high-dielectric materials. Accordingly, in terms of ranges, the relative permittivity (εᵣ) may be from 10 to 60, e.g., preferably from 15 to 55, preferably from 20 to 55, preferably from 25 to 55, preferably from 30 to 55, preferably from 35 to 55 or more preferably from 40 to 55. The RFID device may also be used on packages with a relative permittivity of greater than 60. These high-dielectric materials can significantly affect the performance of RFID tags by altering their resonant frequency and reducing their radiation efficiency.

The relative permittivity and loss tangent (“tan δ”) can be measured by any appropriate method using dielectric spectroscopy or resonator cavities which are commonly used dielectric analysis techniques. At ambient temperature, permittivity and dielectric losses of dielectric materials s can be considered as relatively constant in particular in the bandwidth of interest. The permittivity value of a material and also to its tan δ loss factor at a given frequency for example. Unless otherwise noted, the values indicated in this description and the claims that follow correspond to those measured at any frequency within the band of 800-1000 MHz. The measurements may be test the variation between temperature of 20° C. and freezer temperature of −18° C. In particular, the values relative permittivity and tan δ may be measured by means of a DAK-TL2 using open coaxial probes and relative permittivity and tan δ of the material under test are calculated from the reflection coefficient measured at the probe flange. In DAK-TL2, software calculates the relative permittivity and tan δ constant from the measurement on the basis of the impedance measured at the end of the open-ended coaxial probe connected to a vector network analyzer.

The present disclosure relates to environmentally adaptable RFID devices that overcomes these challenges. By adapting its characteristics based on the surrounding environment, this RFID device may maintain acceptable performance when placed on or near high-dielectric materials. As is used in the art, RFID devices may be referred to as RFID “tags,” RFID “labels” or RFID “inlays,” depending on the specific construction of the RFID device and its intended application. In any case, the disclosed embodiments are equally applicable to any of the variations implied by the different terms, and, as such, the terms are used interchangeably herein. It will be understood that the use of one term does not exclude the others from the scope of the disclosed embodiments.

In some embodiments, an environmentally adaptable RFID device may incorporate antenna designs that are configured for efficient operation across a range of dielectric conditions. These antenna designs may include features such as non-meandering antenna paths, specific impedance-matching techniques, antenna configurations, radiation pattern manipulation, or combinations thereof. The RFID device may be capable of modifying its readability, which may be a composite of sensitivity, backscatter, and radiation patterns, in response to complex dielectric and conductive environments.

In some cases, the RFID device may utilize a high initial resonance frequency in free air, which may shift to the desired operating range when placed on high-dielectric materials. This approach may allow for improved performance in challenging applications, such as tracking meat products in store coolers or identifying items packaged in materials that can attenuate or absorb RFID signals.

In some embodiments, the environmentally adaptable RFID device may provide several potential benefits, including but not limited to improved read range in stacked or cluttered scenarios, enhanced radiation efficiency, and versatility across various applications. These characteristics advantageously may make the device suitable for use in industries such as food packaging, pharmaceuticals, and manufacturing, where high-dielectric materials are commonly encountered.

In some cases, the environmentally adaptable RFID device may include various impedance-matching mechanisms to improve performance in different environments. These mechanisms may include, for example, tuning loops, T-match loops, reversed T-match loops, parasitic conductive elements, interdigital capacitors, and split ring resonators.

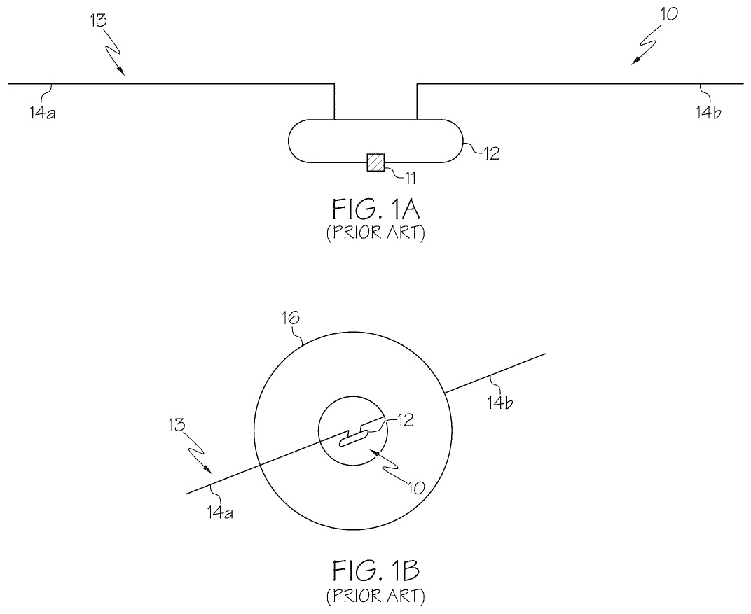

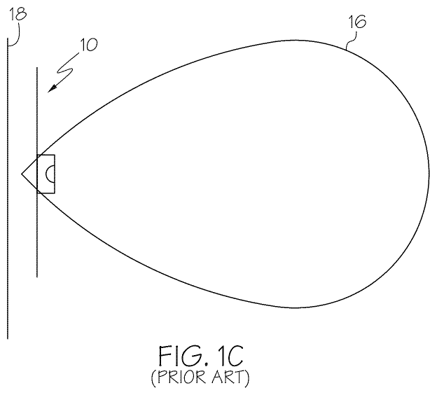

FIG. 1A illustrates a conventional RFID device 10. The RFID device 10 includes a RFID integrated circuit (IC) 11, or “chip,” which is operatively connected to a tuning and impedance-matching loop 12. The tuning and impedance-matching loop 12 may be positioned between the RFID chip 11 and the antenna 13, as shown in FIG. 1A. This particular configuration provides power transfer between the RFID chip 11 and the antenna 13. The antenna 13 of FIG. 1A is formed by two arms 14a and 14b. The dimensions of the tuning and impedance-matching loop 12 and arms 14a and 14b may be configured such that the impedance of the RFID chip 11 is transformed to be the conjugate of the antenna 13 impedance.

FIG. 1B illustrates a radiation pattern 16 associated with the conventional RFID device 10. The radiation pattern 16 may extend outward three-dimensionally (3D) from the RFID device 10 in a toroidal or donut-like shape, which may be a characteristic of many loop antennas. This radiation pattern 16 typically exhibits minimum readability in the “end on” orientation (i.e., outward from arms 14a or 14b), and maximum readability in the “face on” direction (i.e., substantially perpendicular to the end on direction). However, the radiation pattern 16 of the conventional RFID device 10 performs poorly when placed on or near high-dielectric, lossy materials.

The embodiments described herein provide improvements over the conventional RFID device 10 by providing improved designs for efficient operation. In particular, the RFID devices described herein provide improved performance when placed on or near high-dielectric, lossy materials.

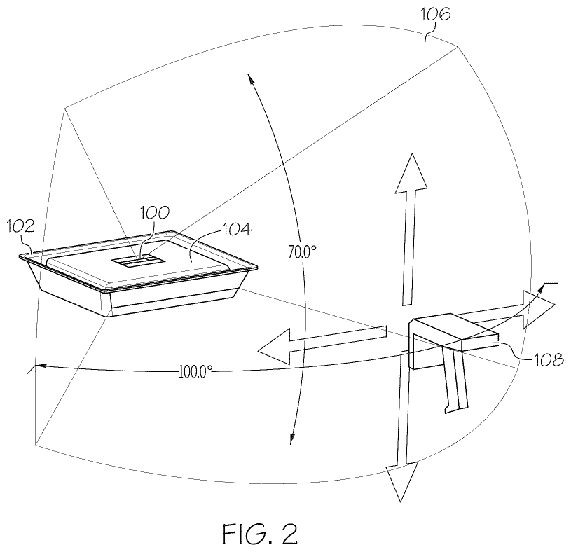

FIG. 2 illustrates a RFID system that may include a RFID device 100 positioned on a package 102 containing a lossy and high-dielectric material 104. RFID device 100 may comprise the RFID integrated circuit chip and an antenna as described further herein. The RFID device 100 may interact with a sensitivity aperture 106 of a RFID reader 108. Particularly, when a RFID reader 108 is activated, a UHF RF signal may be transmitted from the RFID reader 108. In such instances, when the RFID device 100 is influenced under the transmitted UHF RF signal, the antenna of the RFID device 100 receives and transmits back the UHF RF signal to the reader 108 with the information stored in the RFID IC chip.

In some embodiments, the information stored in the RFID IC chip may include, for example, an item identification system, an item locating system, or an item indication system. The item identification system as used herein includes item identification, item location, and item indication in one or more embodiments falling within the scope of the present subject matter.

In FIG. 2, the sensitivity aperture 106 is represented by a curved dome-like structure surrounding the package 102 and RFID device 100. For purposes of illustration, in FIG. 2 the sensitivity aperture is shown to extend 100° horizontally and 70° vertically from the RFID device 100, but it will be appreciated that other dimensions of the sensitivity aperture 106 are possible and, in some cases, desirable.

In some cases, the RFID reader 108 may be in a fixed position. In some cases, the RFID reader may be moved or moveable, as represented by the bold horizontal and vertical arrows. For purposes of discussion herein, a RFID reader 108 may be implemented as a fixed device or may be implemented as a mobile device. In some embodiments, where the relative position of a zone containing an object to which the RFID device is attached, such as a food item, the RFID reader may be fixed within the zone. A fixed RFID reader may be positioned at a point of egress to the zone. In other examples, the fixed RFID reader may be positioned to monitor devices within a sub-zone such as on a shelf, within a fridge, or within a freezer. In some embodiments, the RFID reader may be mobile, where the relative position between the RFID reader and RFID device changes over time. In the latter case, the RFID reader may be, for example, a hand-held reader or a robotic reader.

The function of a RFID device in a volume may be characterized by a number of factors; for example, the sensitivity (a function of realized gain and the minimum power incident at the device's position that will cause it to operate), an associated frequency with an associated 3D angular property (often described as a radiation pattern), or backscatter (the signal generated by the RFID device associated with a modulated change in its cross-section). All of these factors are a function of the environment in the 3D space around the RFID device, characterized as volumes of materials with different dielectric/magnetic and conductive properties at the desired operating frequency. It should be noted that these properties can also be changed by the environment such as, for example, temperature.

Turning now to FIG. 1C, intentional modification of a radiation pattern 16 of a conventional RFID device 10 has typically been performed in the art by using a metal plate 18 or a series of longer and shorter metal rods, as in a Yagi-Uda antenna. FIG. 1C depicts a modified radiation pattern 16 of the conventional RFID device 10 when positioned adjacent to a metal plate 18. In this case, the radiation pattern 16 may become asymmetrical, with the majority of the radiation directed away from the metal plate 18. However, modifications made in this way are generally fixed (i.e., the antenna is always directional under all conditions) rather than designed to create directional peaks in response to a range of different undefined materials to maximize readability. Thus, prior art approaches either add external reflectors or other conductive elements to force the radiation pattern 16 of the RFID device 10 to become directional or use an intrinsically directional design, both of which have their accompanying difficulties and detriments. As may be appreciated, such a permanently directional approach may have the same drawbacks as a permanently omnidirectional design-its inability to adapt to changing environmental conditions renders it less suitable to be read in different situations.

Unlike the conventional approaches, the disclosed RFID devices provide design(s) capable of modifying the device's readability in response to a number of complex dielectric and conductive environments, which beneficially improves the probability of the data in the RFID device being read. In some cases the readability of a device may be a composite of sensitivity, backscatter and/or radiation patterns.

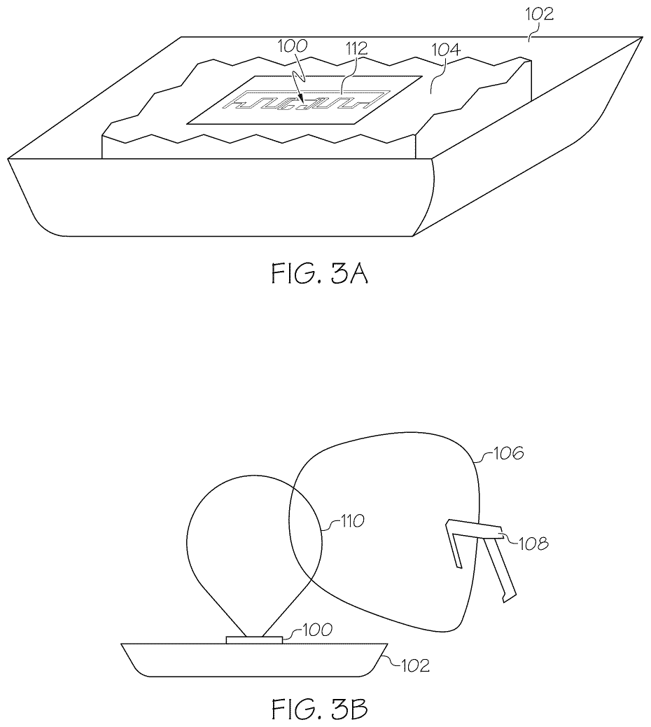

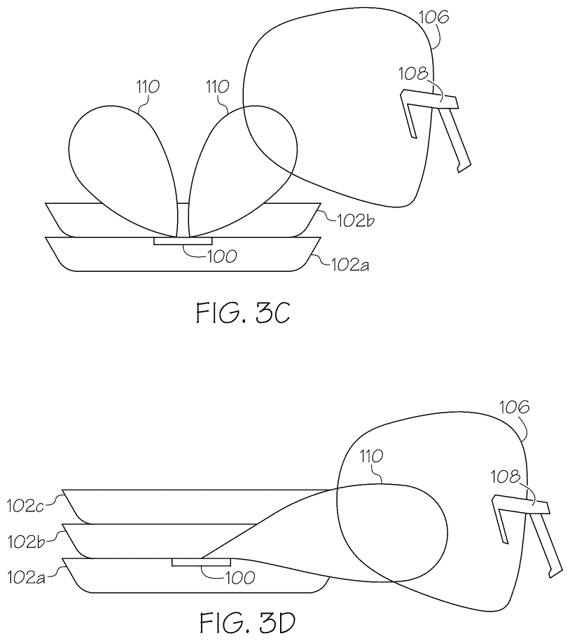

Several exemplary designs will be described in the following text and diagrams. Referring first to FIGS. 3A-D, and according to an embodiment, the adaptive radiation patterns 110 of a RFID device 100 may intersect with a sensitivity aperture 106 of a RFID reader 108. The RFID device 100 may be disposed on a label 112 or contained within a label 112. The label 112 may have at least one surface having an adhesive, preferably a pressure-sensitive adhesive or other similar adhesive. The label 112 may be adhered or otherwise affixed to a package 102 containing the high-dielectric material 104, such as chicken, pork, beef, or other meat products. By adapting its radiation pattern 110 in predetermined ways to intersect with the sensitivity aperture 106 of a RFID reader 108, the RFID device 100 may maintain effective communication with the RFID reader 108 across various environmental conditions.

FIG. 3A shows a RFID device 100 positioned on the top surface of a package 102 that contains a lossy and high dielectric material 104. The RFID device 100 is contained on or within the label 112 that is attached to the top surface of the package 102. Due to variations in packages, the label 112 may be placed at any point on a surface of the package 102, and in some cases, placed on a top surface or face up surface. Exemplary surfaces include the center or outer edge locations on the top surface of the package. In some embodiments, the antenna structure of the RFID device 100 provides operating range when placed on or near the lossy and high dielectric material 104. In one embodiment, the antenna structure of the environmentally adaptable RFID device 100 may be designed with a high initial resonance frequency in free air, which may shift to the desired operating range when placed on or near the lossy and high dielectric material 104. It will be appreciated that the direction for a radiation pattern 110 depends on the location of the RFID reader 108 and, for example, whether the RFID reader 108 moves relative to the package 102. In some cases, the RFID reader 108 may scan a space containing a package 100 of the lossy and high dielectric materials 104.

As depicted in FIG. 3A, the RFID device 100 is located in the center of the top of package 102. The RFID device 300 may be incorporated into a label 112, formed into the body of the package 102, or otherwise attached to the package 102. The position, size, and orientation of the RFID device 100 may be selected to complement its design and the characteristics of its radiation pattern 110 in the various environments in which the RFID device 100 is intended to operate. For example, the RFID device may be sized so it fits within an existing label's dimensions so printers and other food production equipment do not require extensive modifications, if any modifications at all, to incorporate the RFID devices 100. The RFID device 100 may be placed on a package 102 at a location that enhances the readability of the RFID device 100. In some embodiments, the RFID device 100 may be placed toward an edge or corner of a package 102 so it is more readily able to receive RFID interrogation signals from a RFID reader 108 and transmit a RFID response signals back (by being closer to open air on the side of a stack of packages 100).

FIG. 3B depicts a RFID device 100 on a single package 102, demonstrating how the radiation pattern 110 (also referred to as a “lobe of readability”) may propagate outward from the RFID device 100 in such a configuration. The radiation pattern 110 depicted in FIG. 3B is for illustrative purposes only, as any shape or size of radiation pattern 110 that is consistent with embodiments disclosed herein may propagate outward from the RFID device 100.

In the configuration illustrated in FIG. 3B, a RFID reader 108 would likely have a line-of-sight view of the RFID device 100. As noted above, the RFID device 100 may create multiple radiation patterns 110, and/or a differently shaped radiation pattern 110, in response to different environmental conditions. In some embodiments, the RFID device 100 may create at least one directional sensitivity pattern 110 configured to intersect with a read aperture 106 of a RFID reader 108. FIG. 3C illustrates a RFID device 100 positioned on a lower package 102a, on which an upper package 102b has been stacked. Typically, a second RFID device would be positioned on the upper package 102b, but for clarity, only the RFID device 100 of the lower package 102a is depicted in FIG. 3C. In FIG. 3C, each package 102a and 102b may contain a high-dielectric material. It will be appreciated that when the high dielectric materials 104 are meat, e.g., chicken, pork, fish, or some other type of protein, the contents of packages 102a and 102b may not be exactly the same, even if each package 102a and 102b contains the same general type of meat. For example, each package 102a and 102b may contain a slightly different cut of protein, the protein may have a different pattern of fat, there may be slightly different amounts of protein, and so forth. Even with this in mind, the disclosed RFID device 110 should still produce a radiation pattern 110 that is likely to be read by a RFID reader 108. Put another way, the peak gain of an antenna of the RFID device 110 should be within a read aperture 106 of the RFID reader 108 even when the contents of each package 102a and 102b is not uniform. Such a radiation pattern 110 may be depicted, for example, as two lobes extending outward from the sides of the RFID device 110, parallel to the planes of packages 102a and 102b. It will be appreciated that the direction(s) in which the lobes extend in this scenario will be predetermined by the characteristics of the RFID device 100, such as, for example, the various structural elements of the antenna structure as disclosed herein.

FIG. 3D further demonstrates how a RFID device 100 may adapt its radiation pattern 110 when the RFID device 100 is positioned between multiple layers of high dielectric material. In FIG. 3D, a RFID device 100 is disposed on a lower package 102a, an upper package 102b, and a top package 102c (only the RFID device 100 of the lower package 102a is depicted in FIG. 3D for clarity). As shown, the radiation pattern 110 of the RFID device 100 of the lower package 200a may extend primarily to the side of the stacked packages 102a-c. As transmitting through multiple layers of packages 102b, 102c and associated high-dielectric materials would be difficult in some cases, if not impossible, it will be appreciated that having a radiation pattern 110 that extends to the side (i.e., toward an air gap, open region, RFID reader 108, or the like) may allow for effective signal transmission even when the RFID device 100 is sandwiched between such high-dielectric materials.

To overcome the challenges associated with high-dielectric materials, the environmentally adaptable RFID device may incorporate design features that allow for improved performance in high-dielectric environments. A number of factors have been found to improve the performance of the environmentally adaptable RFID device in multiple environments and may create environmentally dependent directional properties. One skilled in the art will appreciate that although they are described separately herein, one or more of these features may be active at one time to achieve the desired performance.

For example, the improved performance may result from designing an antenna structure whose radiating elements bring a high resonance frequency in free air above the assigned operational frequency band for RFID in the country or region associated with the application. For example, the operational frequency band could be 902-928 MHz in the USA, 865-868 MHz in some parts of Europe, and 860-930 MHz according to the GS1 “Gen2” air interface protocol. Using an initial high frequency ensures that when the environmentally adaptable RFID device is placed proximate to a high-dielectric material, it falls into the desired operating frequency range. In other words, the dielectric loading effect may lower the resonance to the desired operating range.

At resonance, the current distribution of a half-wave dipole along the antenna's length forms a standing wave with a maximum at the center and a minimum at the ends. This distribution is ideal for efficient radiation, as it increases the antenna's effective area and the strength of the electromagnetic field it generates. In a folded dipole operating at its half-wave resonance, the current along the shorted parallel conductors forms a standing wave, characterized by two current maxima and two minima along the structure. When the total perimeter of the folded dipole approaches one full wavelength, the folded dipole antenna behaves like a full-wave loop antenna and begins to support higher-order standing-wave modes.

Balancing radiation efficiency and impedance-matching—both of which are desirable characteristics—presents a challenge: a larger antenna footprint improves radiation efficiency, while a smaller dipole ensures better impedance-matching.

Antenna radiation efficiency can also be expressed as:

$${η}_{r} = {P}_{r a d} / {P}_{in}$$

where:
P_{rad} is the radiated power by the antenna; and
Pᵢₙ is the input power supplied to the antenna.

Antenna total efficiency can also be expressed as:

$${η}_{t} = {P}_{r a d} / {P}_{incidental}$$

where:
P_{rad} is the radiated power by the antenna; and
P_{incidental} is the incidental power supplied to the antenna.

For purposes of the present disclosure, the total efficiency, radiation efficiency, and/or IC impedance matching efficiency were measured on a model of a double stacked chicken. The RFID devices were placed in the center of two chicken packages. Each package of chicken was on a foam tray and wrapped in a polyamide film. The foam tray had a thickness of 4.5 mm and a relative permittivity εᵣ=1.1, loss δ=0.046. The polyamide film had a thickness of 0.02 mm and a relative permittivity εᵣ=4.3, loss δ=0.004. The chicken had a dimension of 380 mm×225 mm with a thickness of 40 mm. The relative permittivity of the chicken was εᵣ=56.8, loss δ=0.38.

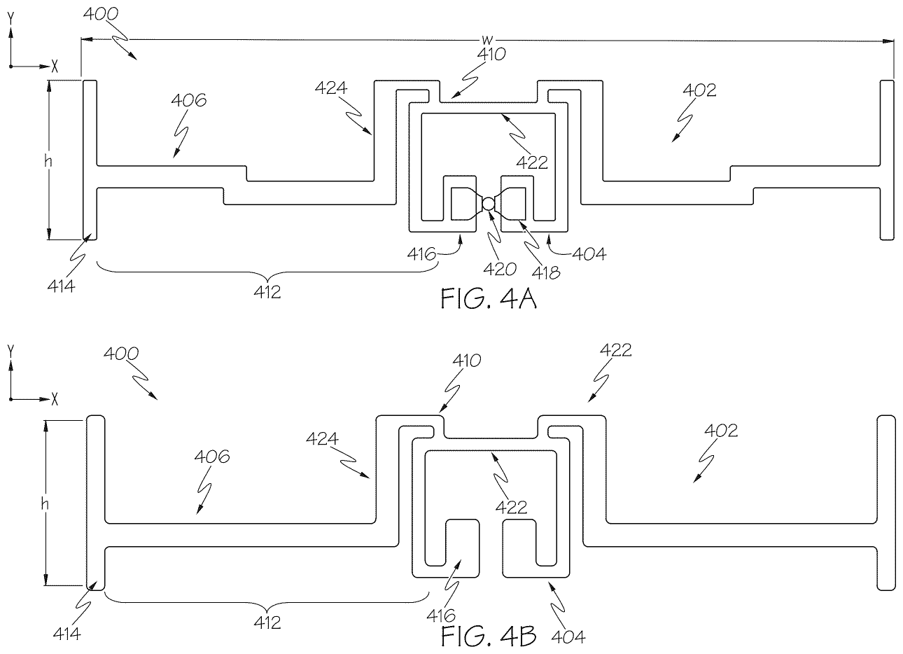

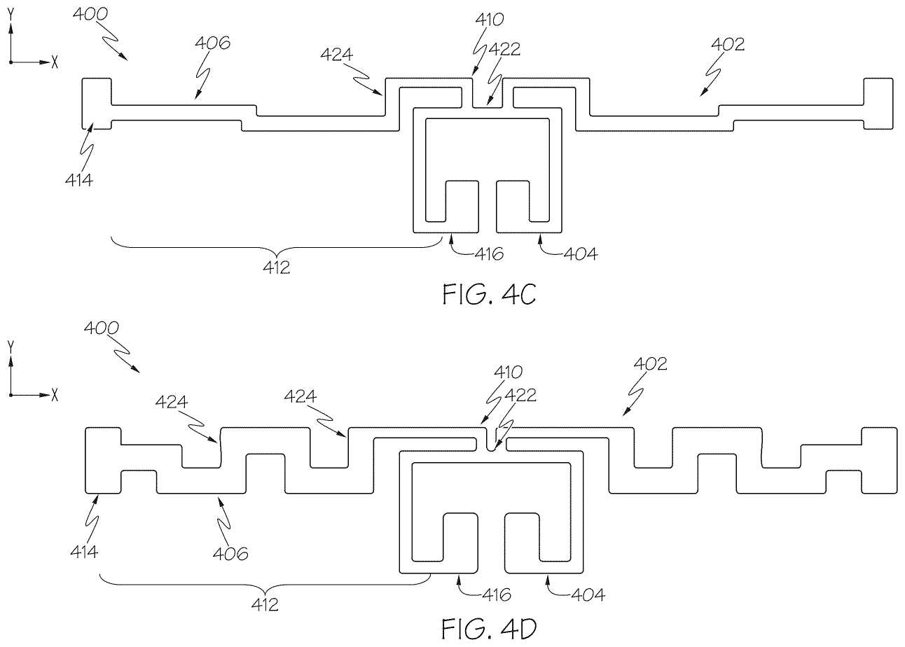

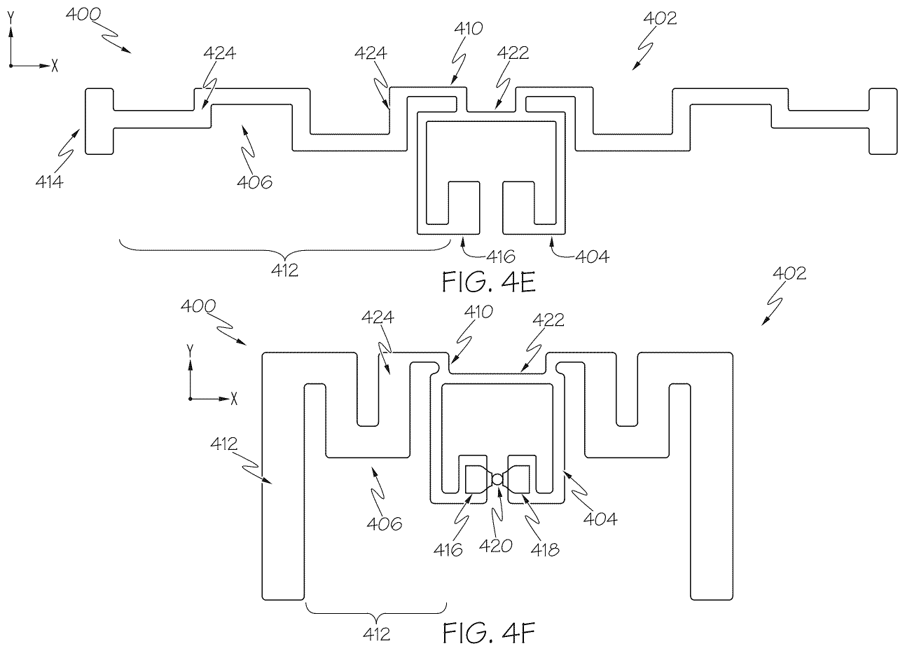

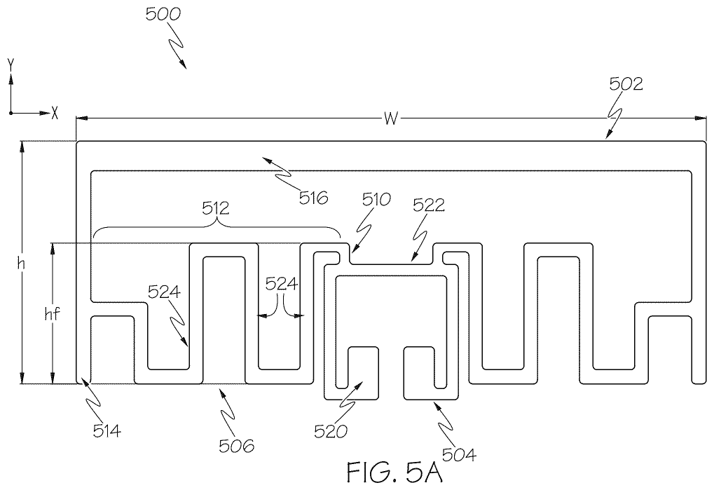

FIGS. 4A-4F shows a RFID device 400 having a normal dipole antenna 402. The normal dipole antenna 402 has a width (w) in line with the x-axis or longitudinal direction and a height (h) in line with the y-axis. In one embodiment, the width (w) and height (h) are selected to be sized to a label that is applied to a package containing a high-dielectric material. An aspect ratio may be determined by dividing the maximum width and maximum height. The length of the dipole antenna on the x-axis, which is the maximum width, may range from 30 mm to 280 mm, e.g., preferably 40 mm to 250 mm, and more preferably from 50 mm to 200 mm. In one embodiment, the normal dipole antenna 402 may have an aspect ratio of 3 to 7, e.g., preferably an aspect ratio of 3.8 to 6.4 or more preferably an aspect ratio of 4.7 to 5.2. Accordingly, the maximum width may be longer than the maximum height. Accordingly, the maximum height on the y-axis of the normal dipole antenna 402 may be from 10 mm to 40 mm, e.g., preferably may be from 10 mm to 30 mm, and more preferably may be from 13 to 20 mm. FIGS. 4C-4E represent normal dipole antenna 402 having a higher aspect ratio and thus an accompanying reduced height on the y-axis.

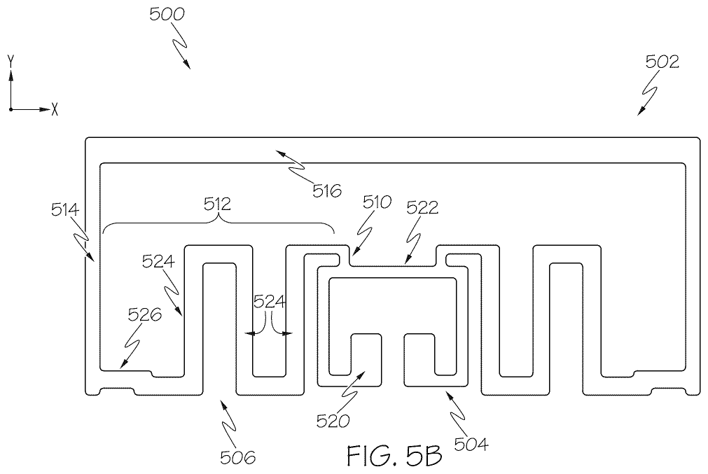

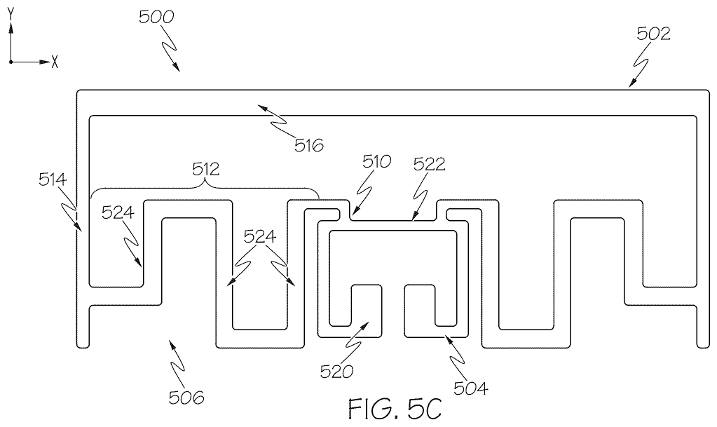

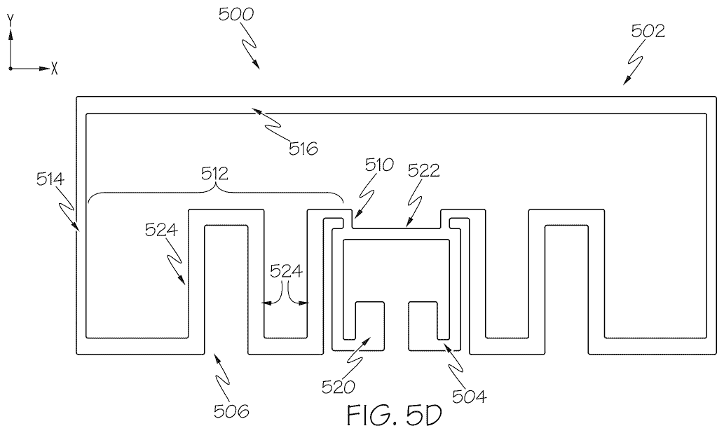

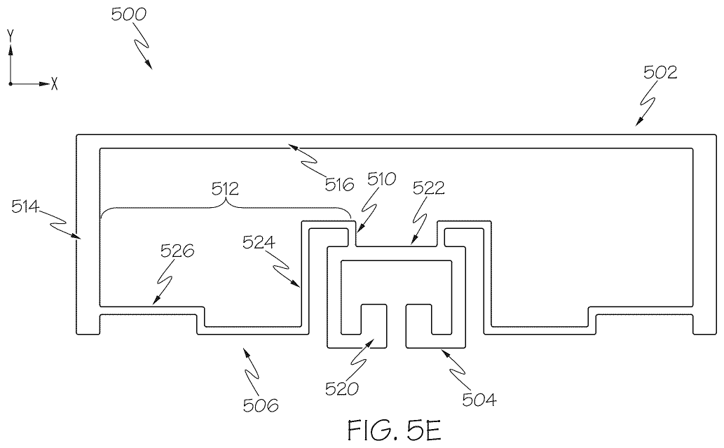

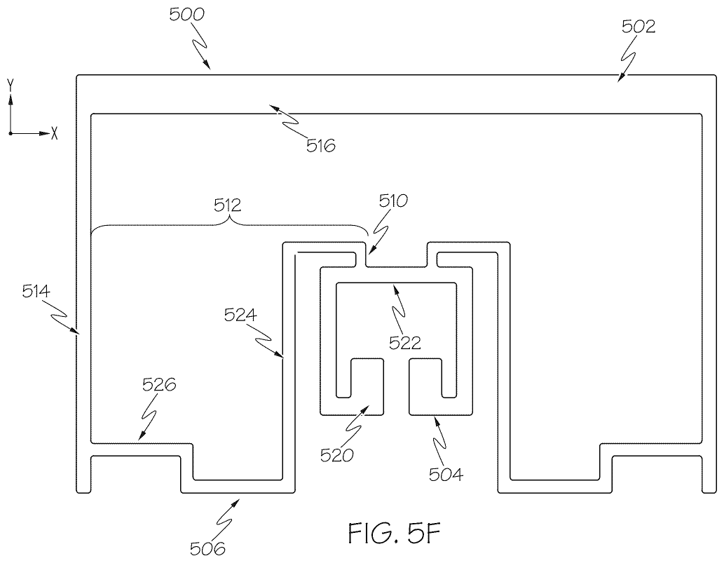

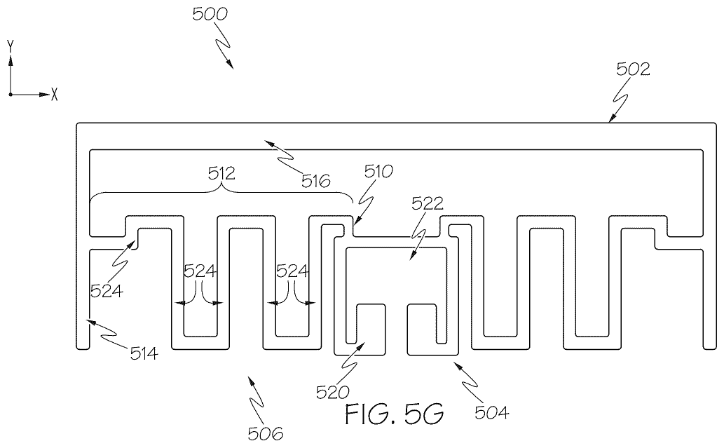

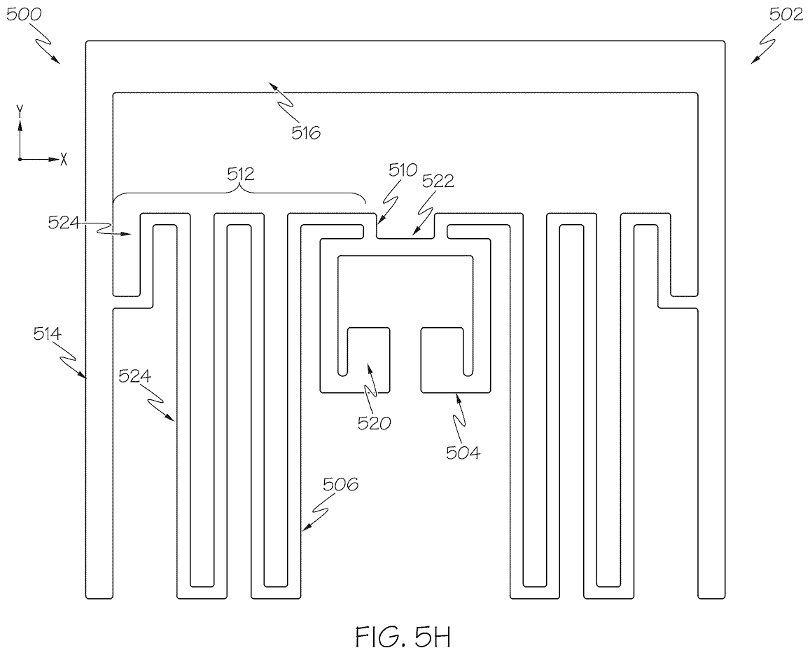

The normal dipole 402 antenna comprises a loop segment 404 and emission segments 406. In one embodiment, the emission segments 406 are symmetrical opposed in the center of the normal dipole antenna 402. Each emission segment 406 for the normal dipole antenna 402 comprises a connection portion 410, a folded portion 412, a longitudinal edge portion 414. Unlike the folded dipole shown in FIGS. 5A-5H below, the emission segments 406 of normal dipole of FIGS. 4A-4F are not connected.

The loop segment 404 and emission segments 406 may be formed as conductive traces. The conductive trace may be formed from electrically conductive material, such as copper, aluminum, silver, and including alloys thereof as well as conductive inks. In some embodiments, a single sheet of metal such as, for example, aluminum sheet or foil may be cut to form the antenna described herein. The metal sheet may be cut using for example any conventional antenna cutting methods or techniques such as die cutting, laser cutting, etching and so forth. Unless otherwise specified by the parameters disclosed herein, the conductive traces for loop segment 404 and emission segments 406, including the portions thereof, may each independently have an average width from 0.3 mm to 3 mm, e.g., from 0.5 mm to 2.5 mm or from 0.7 mm to 1.5 mm. In one embodiment, the conductive trace may be substantially uniform for each of the loop segment 404 and emission segments 406, including the portions thereof.

The loop segment 404 comprises pads 416 at each end and the pads 416 may be separated by a gap. The pads 416 may be in a symmetrical configuration. The RFID device 400 may have one or more straps 418 configured to connect the pads 416 of the loop segment 404 to an integrated circuit (IC) chip 420. In one embodiment the IC chip may be a UHF RFID chip.

The connection portion 410 of the emission segments 406 are connected with the top portion of the loop segment 404 opposite to the pads 416. Each connection portion 410 is separated by a conductive span 422. The conductive span 422 and loop segment 404 may share the conductive trace. In some embodiments, the conductive trace of the connection portion 410 may have a similar or substantially similar width as the loop segment 404. As shown in FIG. 4D, the conductive span 422 may be relatively narrower, but it is sufficiently wide to separate each of the emission segments 406.

The folded portion 412 is positioned between the connection portion 410 and a longitudinal edge portion 414. The folded portion 412 may have at least one vertical section 424. The vertical sections 424 may create folds or a non-linear portion. A vertical section refers to a portion of the conductive trace in line with the y-axis in the course of extending from the connection portion 410 to the longitudinal edge portion 414. The height of the vertical section 424 may be less than the height of the normal dipole 402. Each vertical section 424 may have a different height.

In some embodiments, the normal antenna 402 may have a folded portion 412 with one vertical section 424 as shown in FIG. 4B. In other embodiments, the normal antenna 402 may have a folded portion 412 with multiple vertical sections 424, as shown in FIGS. 4D-4F.

The folded portion 412 may be joined along any portion of the longitudinal edge portion 414. Preferably, the folded portion 412 may be joined to a midpoint of the longitudinal edge portion 414 as shown in FIGS. 4A-4E. In other embodiments, the folded portion 412 may be joined to a lower portion of the longitudinal edge portion 414. As shown in FIG. 4F, the folded portion 412 may be joined to the top portion of the longitudinal edge portion 414. The longitudinal edge portion 414 represents the farthest conductive edge from the center of the dipole antenna 402.

In some embodiments, the longitudinal edge portion 414 has a conductive trace that has a similar or substantially width as the folded portion 412. As shown in FIGS. 4D and 4F, the longitudinal edge portion 414 and the folded portion 412 both have a relatively thicker conductive trace. In some embodiments, the longitudinal edge portion 414 may be slightly wider than the folded portion 412 as shown in FIGS. 4C and 4E.

The normal dipole antennas of FIGS. 4C-4E were simulated and found to have a total radiation efficiency of 0.09% to 0.1%. The normal dipole antenna of FIG. 4F was tested with the double stack chicken model described herein and found to have a total radiation efficiency of 0.085%.

Turning now to FIGS. 5A-5H and the folded dipole antenna that may be used with one or more embodiments described herein. FIGS. 5A-5H shows a RFID device 500 having a folded dipole antenna 502. The folded dipole antenna 502 has a width (w) in line with the x-axis or longitudinal direction and a height (h) in line with the y-axis. In one embodiment, the width (w) and height (h) are selected to be sized to a label that is applied to a package containing a high-dielectric material. An aspect ratio may be determined by dividing the maximum width and maximum height. The length of the loop antenna on the x-axis, which is the maximum width, may range from 41 mm to 70 mm, e.g., preferably ranging from 42 mm to 65 mm, and more preferably ranging from 47 mm to 57 mm. In one embodiment, the folded dipole antenna 502 may have an aspect ratio of 1.3 to 3.4, e.g., preferably an aspect ratio of 1.5 to 3.3 or more preferably an aspect ratio of 2.5 to 3.2. An aspect ratio that is closer to 3.4 is represented in FIG. 5E, while an aspect ratio that is closer to 1.3 is represented in FIG. 5F. Accordingly, the maximum width may be longer than the maximum height. Accordingly, the maximum height on the y-axis of folded dipole antenna 502 may be from 11 mm to 53 mm, e.g., preferably may be from 19 mm to 31 mm, and more preferably may be from 21 to 25 mm.

The folded dipole antenna 502 comprises a loop segment 504 and emission segments 506. In one embodiment, the emission segments 506 are symmetrical opposed in the center of the folded dipole antenna 502. Each emission segment 506 for the folded dipole antenna 502 comprises a connection portion 510, a folded portion 512, a longitudinal edge portion 514, and a line portion 516. In some embodiments, the emission segments 506 are joined together by the line portion 516 on the top edge of the folded dipole antenna 502 to form a loop. In one embodiment, the loop is continuous. Generally speaking, the terms “top”, “bottom”, “left”, and “right” are relative and are used to orient the outer edges without limiting the device to a particular orientation.

The loop segment 504 and emission segments 506 may be formed as conductive traces. The conductive trace may be formed from electrically conductive material, such as copper, aluminum, silver, and including alloys thereof as well as conductive inks. Unless otherwise specified by the parameters disclosed herein, the conductive traces for loop segment 504 and emission segments 506, including the portions thereof, may each independently have an average width from 0.3 mm to 3 mm, e.g., from 0.5 mm to 2.5 mm or from 0.7 mm to 1.5 mm. In one embodiment, the conductive trace may be substantially uniform for each of the loop segment 504 and emission segments 506, including the portions thereof.

The loop segment 504 comprises pads 520 at each end and are separated by a gap. The pads 520 may be in a symmetrical configuration. The RFID device 500 may have one or more straps (not shown) configured to connect the pads 520 of the loop segment 504 to an integrated circuit (IC) chip (not shown). In one embodiment the IC chip may be a UHF RFID chip.

In some embodiments, the loop segment 504 may have a height on the y-axis preferably ranging from 5 mm to 20 mm, e.g., ranging from 8 mm to 15 mm or ranging from 10 mm to 12 mm. The height on the y-axis should be sufficient to accompany the pads, straps, and/or IC chip. The loop segment 504 may be a circle, oval, rectangle or other similar shape. In some embodiments, the loop segment 504 may be a rounded rectangle or rounded square. The width of the loop segment 504 on the x-axis may range from 5 mm to 20 mm, e.g., ranging from 8 mm to 15 mm or ranging from 10 mm to 12 mm. In some embodiments, the height and width of the loop segment 504 may be substantially similar. To achieve improved performance, the loop segment 504 accordingly may have a loop length that is no more than 55 mm, and the width and height are selected to fall below this size. Having a loop length of greater than 55 mm leads to deteriorating performance. The loop length is the sum of the loop segment path and includes the conductive span 522 that may be shared with emission segment 506. In some embodiments, the loop length may be from 41 mm to 55 mm, e.g., from 43 mm to 51 mm or from 45 mm to 50 mm.

The connection portion 510 of the emission segments 506 are connected with the top portion of the loop segment 504 opposite to the pads 520. Each connection portion 510 is separated by a conductive span 522. The conductive span 522 and loop segment 504 may share the conductive trace. In some embodiments, the conductive trace of the connection portion 510 may have a similar or substantially similar width as the loop segment 504. In one embodiment, the conductive span 522 has a length that is greater than the gap separating the pads 520.

The folded portion 512 is positioned between the connection portion 510 and a longitudinal edge portion 514. The folded portion 512 may have at least one vertical section 524. The vertical sections 524 may create folds that bend at sharp angles. A vertical section refers to a portion of the conductive trace in line with the y-axis in the course of extending from the connection portion 510 to the longitudinal edge portion 514. The fold height (hf) of the vertical section 524 may be defined by the gap of the connection portion 510 from the loop segment 504 and the lower end of the longitudinal edge portion 514 as shown in FIG. 5A. Each vertical section 524 may have a different height, but preferably there is at least one vertical section 524 having a height that is substantially equal to the fold height (hf). Vertical section 524 have a height less than the fold height (hf) may be defined as partial folds 526. Accordingly a partial fold 526 has at least one vertical section 524 that is less than the fold height (hf).

FIGS. 5A, FIG. 5B, FIG. 5E and FIG. 5F each illustrate a folded dipole antenna 502 having partial folds 526 with different fold heights, but still have at least one vertical section 524 that is substantially equal to the fold height (hf). While in FIG. 5C and FIG. 5D, the folded portion 512 has vertical sections 524 without any partial folds. In some embodiments, the number of vertical sections 524 for the folded portion may be greater than 1, e.g., greater than 1.5, greater than 2, greater than 2.5 or greater 3. In terms of ranges, the number of vertical sections 524 may be from 1 to 6, e.g., from 1.1 to 5, from 1.2 to 4, from 1.3 to 3.5 or from 2.6 to 3.2. Increasing the number of vertical sections 524 may allow for compact design of the folded dipole antenna 502 without an increase of the width (w) of the dipole antenna 502. FIG. 5G shows a folded portion 512 having 4.1 vertical sections 524 and FIG. 5H shows a folded portion 512 having 4.1 vertical sections 524.

In some embodiments, the folded dipole antenna 502 may have a folded portion 512 and/or a longitudinal edge portion 514 that is in line with the bottom edge of the loop segment 504, as shown in FIGS. 5D and 5G. In other embodiments, folded portion 512 and/or a longitudinal edge portion 514 may extend in a direction in line with the y-axis that is greater than the bottom edge of the loop segment 504, as shown in FIGS. 5F and 5H.

The folded portion 512 may be joined along any portion of the longitudinal edge portion 514. Preferably, the folded portion 512 may be joined to a midpoint of the longitudinal edge portion 514 as shown in FIG. 5A. In other embodiments, the folded portion 512 may be joined to a lower portion of the longitudinal edge portion 514 as shown in FIG. 5B or FIG. 5D. In some embodiments, the partial fold 526 may be joined along any part of the longitudinal edge portion 514 as shown in FIG. 5D. The longitudinal edge portion 514 represents the farthest conductive edge from the center of the dipole antenna 502. In some embodiments, the longitudinal edge portion 514 has a conductive trace that has a similar or substantially width as the folded portion 512. Preferably, the folded portion 512 and line portion 516 are connected through the longitudinal edge portion 514 and not directly connected.

The line portion 516 is positioned on the top edge of the dipole antenna 502. In some embodiments, the line portion 516 is a straight line in line with the x-axis. The conductive trace that defines the line portion 516 may have a width that is larger than the longitudinal edge portion 514 or the folded portion 512.

For folded dipole antenna 502 it is preferred that each emission segment 506 is joined to define a perimeter. The perimeter of the emission segments 506, when joined, may be longer than the loop length of the loop segment 504. The perimeter includes the path of each portion of the emission segment 506 as well as the shared conductive span 522. In some embodiments, the perimeter of the folded dipole antenna 502 may be from 168 mm to 282 mm, e.g., from 175 mm to 275 mm or from 190 mm to 230 mm.

The folded dipole antenna 502 has certain parameters that have led to improved performance. The improved performance may have a total efficiency % of at least 0.09% or more with an IC impedance matching efficiency (tau) of at least 0.45 or more. For purposes of this disclosure the total efficiency and IC impedance matching efficiency are determined from 902 to 928 MHz. To achieve high performance, the folded dipole antenna 502 may be constructed to have an antenna width from 41 mm to 70 mm, a loop length of the loop segment from 41 mm to 55 mm, an aspect ratio of 1.3 to 3.4 and a perimeter from 168 mm to 282 mm. In a preferred embodiment, the folded dipole antenna 502 may be constructed to have an antenna width from 47 mm to 57 mm, a loop length of the loop segment from 45 mm to 50 mm, an aspect ratio of 2.5 to 3.2, and a perimeter from 190 mm to 230 mm. In some embodiments, the folded dipole antenna 502 may have a folded portion 512 having 1 or more vertical sections 524. In some embodiments, the total efficiency % may be from 0.09% to 0.16%, e.g., from 0.1% to 0.15% or from 0.11% to 0.14%. The IC impedance matching efficiency may be from 0.45 to 0.8, e.g., from 0.5 to 0.7 or from 0.55 to 0.65. In some embodiments, the radiation efficiency may be from 0.14 to 0.25, e.g., from 0.16 to 0.22 or from 0.17 to 0.21.

In some embodiments, the antenna configuration may have at least one external edge that is meandering, which is characterized by a back-and-forth antenna pattern or the vertical sections shown in the normal and folded dipoles. In some embodiments, to achieve a high initial resonance, an antenna of the environmentally adaptable RFID device may have a line portion on the top edge for folded dipoles that uses a non-meandering geometry, which minimizes its electrical length while maintaining the necessary length for efficient radiation. In the context used herein, “non-meandering” refers to an edge of the top an antenna structure of the RFID device that is substantially straight or curved.

In some embodiments, the normal dipole may have a longitudinal edge portion that is non-meandering and the folded dipole may have a longitudinal edge portion and/or a top line portion that is non-meandering. In some embodiments, a non-meandering edge of the antenna may be preferred and such constructs may avoid areas of high current density, which would occur at the tight bends characteristic of a meandering antenna and decrease the antenna's radiation efficiency.

In addition, various embodiments contemplate that an environmentally adaptable RFID device may have dimensions selected such that when the antenna interacts with high-dielectric materials, its resonance shifts down into the appropriate frequency band. As a result, an antenna designed for use with high-dielectric materials may be shorter than one designed for operation in free air. However, both the smaller size and the dielectric losses may reduce radiation resistance and efficiency.

According to an embodiment, an antenna design for an environmentally adaptable RFID device that will be used with high-dielectric materials involves a balance of electrical length and physical size. While a shorter electrical length may be desirable for achieving the necessary high resonance frequency, a larger physical size—and therefore a greater surface area—typically increases radiation resistance. This increased resistance enhances the antenna's radiation efficiency, boosting its performance when applied to high-dielectric materials. However, the antenna's size may also need to be defined to fit within the constraints of the primary or secondary label, as in the case of protein tagging. In addition, increasing the size of an antenna will eventually result in a decrease of the antenna's resonance frequency.

The differences in efficiency and frequency response among these antenna designs demonstrate how various configurations of the antenna structure may affect the performance of an environmentally adaptable RFID device in different environments. By improving the antenna design, the environmentally adaptable RFID device may maintain effective operation across a range of challenging conditions, such as when placed on or near a lossy, high-dielectric material.

In addition, low capacitance and high inductance drives a response from the antenna that is primarily magnetic, rather than electrical, in nature. In other words, creating an electric field maxima that is as small as possible (given the relevant design constraints) causes most of the energy of the antenna to be directed toward generating a magnetic field. This is significant because a magnetic field can more effectively pass through high-dielectric materials than an electrical field, which tends to be absorbed or otherwise impeded.

In some embodiments, the RFID device uses an antenna having at least two loops. Preferably, one loop is contained within the larger loop. For purposes of the present disclosure the larger loop may be referred to as the loop antenna and the smaller loop as the feeder loop or matching loop. Each loop may share a conductive trace and may be overlapped. Although two loops are generally sufficient, other embodiments may use one or more loops.

In one embodiment, the conductive trace may be substantially uniform around the perimeter of each loop. In one embodiment, the conductive trace defines a hollow area for the loop. The hollow area may be at least 20% or more of the total area defined by the conductive trace, and preferably at least 85% or more preferably at least 90%.

A folded dipole antenna may define a hollow area with the conductive trace for one or more loops may reduce the amount of conductive material in contact with the high-dielectric material, minimizing the dielectric loading effect and helping to maintain the desired resonant frequency while reducing losses. Reducing the amount of conductive material may also have other benefits. For example, a reduced amount of conductive material may reduce the interaction of the RFID device may have with metal detector systems found in food processing facilities. In another example, the reduced metal content of a RFID device that is attached to a package (or is part of a label that is attached to a package) may have beneficial effects when the package is recycled, as there will be less conductive material to be separated from other recyclable materials. It should be understood that the normal dipole antenna disclosed herein does not define a hollow area.

In some embodiments, at least one of the loop defined by the folded dipole antenna may have a solid construction, with less than 20% of the area defined by the conductive trace as being open. The larger loop may have a solid construction with less than 20% of the area being open. Although solid construction may be used in some embodiments, it is preferred to use folded dipole antenna configurations with conductive traces that define a hollow area that is more than 20% of the total area of the folded dipole antenna.

The dipole and folded dipole antenna configurations depicted herein have advantages over conventional dipole RFID antenna designs. Conventional dipole RFID antennas have demonstrated that they are not well-suited for use in proximity to high-dielectric materials. As noted above, conventional antennas have many bends that create undesirable areas of high current density. However, in many cases, even if a conventional antenna is straightened out to create a straight dipole, such an antenna is unlikely to work well in proximity to high-dielectric materials. Rather, the various configurations of dipole and folded dipole antennas disclosed herein exhibit the desirable properties of, for example, low capacitance and high inductance, which enable more effective tuning of the antenna.

In addition, low capacitance and high inductance drives a response from the antenna that is primarily magnetic, rather than electrical, in nature. In other words, creating an electric field maxima that is as small as possible (given the relevant design constraints) causes most of the energy of the antenna to be directed toward generating a magnetic field. This is significant because a magnetic field can more effectively pass through high-dielectric materials than an electrical field, which tends to be absorbed or otherwise impeded.

RFID devices shown herein comprising a dipole antenna may be adhered or otherwise affixed to a label. The label may be applied to the package containing the high-dielectric material. In some embodiments, the RFID device may be directly applied to the package without using a label. In some embodiments, the antenna may create at least one directional sensitivity pattern configured to intersect with a read aperture of a RFID reader. The antenna improves the read rate of the RFID device when the RFID device is placed on packages containing high-dielectric materials.

RFID devices shown herein comprising a RFID integrated circuit chip and an antenna may be adhered or otherwise affixed to a label. The label may be applied to the package containing the high-dielectric material. In some embodiments, the RFID device may be directly applied to the package without using a label. In some embodiments, the antenna may create at least one directional sensitivity pattern configured to intersect with a read aperture of a RFID reader. The antenna improves the read rate of the RFID device when the RFID device is placed on packages containing high-dielectric materials. In one embodiment, the RFID device is applied to a package containing a high-dielectric material the read rate of the RFID device may be greater than or equal to 75%, e.g., greater than or equal to 85% or greater than or equal to 95%. The location of the RFID device on the package may influence the read rate, with read rates being higher on the edges than the center and the top edge of the package generally having higher read rates.

In an embodiment, any of the RFID devices disclosed herein may be combined with a low-loss, low-dielectric (e.g., 1-2 εᵣ) spacer on one or both sides of the RFID device to create separation from high-dielectric materials. In many use cases, the spacer may be needed on both sides of the RFID device to maintain separation from both the package to which the RFID device is affixed, as well as to another package that may be placed on top of the RFID device (for example, as illustrated in FIGS. 3B-D). The stacking can be up to several packages high, and in some cases as many as six packages high, so the presence of a spacer that increases readability could be particularly useful in such situations. The spacer material could be, for example, various types of polyethylene (PE) foam, cavitated polypropylene (PP), polyethylene terephthalate (PET), paper, cardboard, or the like. In some embodiments, the thickness of the spacer is selected so the completed product (e.g., RFID device, the spacer, and the label to which both are attached) can pass through printers and applicators without issues. In such embodiments, the combined thickness of the spacer, the RFID device, and any other layers (e.g., facestock, adhesives, etc.) should be less than 51 mm, e.g., less than 45 mm, less than 40 mm, less than 35 mm, less than 25 mm or less than 20 mm, at least during the printing and application of an inlay or label of which the RFID device may be a part. It will be appreciated that the spacer may have dimensions that are the same or different than the label or the RFID device. In one embodiment, the spacer may be positioned substantially on the bottom and/or top of the RFID device, even if a label to which the RFID device is attached has a larger footprint. In another embodiment, the spacer may cover the entire area of the label.

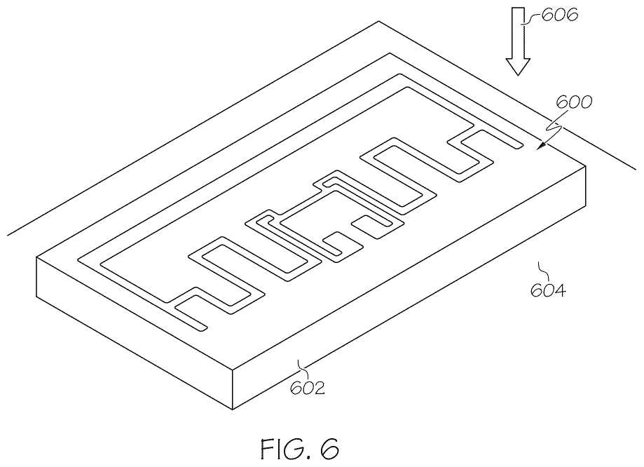

FIG. 6 depicts a RFID device 600 that has been attached, or placed adjacent to, a spacer 602. FIG. 6 further depicts the RFID device 600 being attached to a surface 604 of a dielectric material or package with the spacer 602 in between, typically by using an adhesive (not shown). As noted above, in an embodiment the spacer 602 is comprised of a low-loss, low-dielectric material (e.g., 1-2 εᵣ). Although not shown in FIG. 6, the spacer 602 may be encapsulated by a face layer or similar polymeric layer. This encapsulation may reduce or prevent delamination.

The spacer 602 of FIG. 5 may, in one embodiment, resist compression forces that may occur substantially in the direction indicated by arrow 606. In such an embodiment, the objective may be to maintain an amount of separation between the RFID device 600 and the surface 604. In another embodiment, when the RFID device 600 is placed in a stack of packages, the material thickness of the spacer 602 changes to allow the RFID device 600 to provide improved performance and the radiation lobes (i.e., radiation pattern) required for desired performance.

In some embodiments, the spacer may be a low-density material comprising hollow spheres, air gaps or air pockets. In some embodiments, the spacer may be foamed polymeric film, cavitated polymeric films, patterned adhesives, foamed adhesives, or any combination thereof. In some embodiments, the spacer may be a topcoat, an adhesive, a primer, an ink layer or any combination thereof comprising hollow spheres including but not limited to polymeric beads, glass beads, glass bubbles or a combination thereof. The hollow spheres or foam or cavities create air gaps and air pockets in the spacer, which in turn creates a low-density environment around the RFID device. The low-density environment around the RFID device helps the RFID device to efficiently operate across a range of dielectric conditions, including high dielectric and conducting environments.

In some cases, the spacer may be a topcoat, an adhesive, a primer, an ink layer or any combination thereof, which is configured to expand upon exposure to an external stimulus. In such cases, the spacer may include expandable particles, foamable materials, or a combination thereof, which on exposure to external stimulus leads to expansion of the spacer. The external stimulus may be, but is not limited to, thermal, physical, radiation, electrical, sound, chemical, magnetic or any combination thereof. For example, in some embodiments the wireless label construction may be exposed to thermal stimuli, including but not limited to induction heating and IR lamps. Examples of physical stimuli may include but are not limited to pressure, vibrations, ultra-sonication, and any combination thereof. Examples of radiation stimuli include but are not limited to UV radiation, laser radiation, electron beam radiation, electromagnetic radiation and any combination thereof.

In some embodiments, the spacer may have a polymeric matrix comprising a polymer selected from starch, vinyl acetate ethylene dispersion, polyvinyl acetate, polyvinyl acetate, polyvinyl alcohol, dextrin stabilized polyvinyl acetate, polyvinyl acetate copolymers, vinyl acetate-ethylene copolymers, vinyl acrylic, styrene acrylic, acrylic, styrene butyl rubber, polyurethane or any combination thereof. In accordance with some embodiments of the present invention, the plasticizer may be selected from the group consisting of polyfunctional alcohol, polyoxyalkylene or polyoxyalkylene derivative (e.g. glycerol, dibenzoates such as diethylene glycol dibenzoate and dipropylene glycol dibenzoate), polyethylene glycol, polyethylene glycol monomethyl ether, polyethylene glycol monoethyl ether, polyethylene glycol dimethyl ether, polyethylene glycol diethyl ether, polypropylene glycol, polybutylene glycol or their copolymers or any combination thereof. The spacer, based on dry weight, may comprise from 20 to 70% by weight of the polymeric matrix and 15 to 50% by weight of the plasticizer, and from 25 to 60% by weight of expandable particles.

In some embodiments, the spacer may comprise an acrylic emulsion having a nonionic surfactant and expandable particles. The acrylic emulsion may comprise 35 to 98% by weight of an alkyl acrylate, 0 to 35% by weight of vinyl ester, 0 to 40% by weight of a diester of a dicarboxylic acid, and 0 to 10% of an unsaturated carboxylic acid. These % by weight are based on the total weight of the acrylic emulsion. The alkyl acrylate may preferably contain from about 4 to about 8 carbon atoms in the alkyl group, preferably 2-ethyl hexyl acrylate or butyl acrylate. The vinyl ester may preferably contain from 2 to about 16 carbon atoms in the alkyl chain of the ester, preferably vinyl acetate. Each alkyl group of the diester independently contains from about 6 to about 16 carbon atoms, with di-2-ethyl hexyl maleate or di-2-ethyl hexyl fumarate being preferred. The unsaturated carboxylic acid may contain from 3 to about 5 carbon atoms, preferably acrylic and/or methacrylic acid. The acrylic emulsion may have a glass transition temperature of less than about −30° C.

The acrylic emulsion may also contain a nonionic surfactant in an amount from 0.4 to 5% by weight of the acrylic emulsion. Suitable nonionic surfactants may include polyethylene polyoxypropylene block copolymers and nonionic emulsified waxes.

The expandable particles may include a polymeric shell and a core. In an embodiment, the expandable particles are thermally expandable particles. The polymeric shell may be made of polymers including but not limited to vinylidene chloride-acrylonitrile copolymers, polyvinyl alcohols, polyvinyl butyrals, polymethyl methacrylates, polyacrylonitriles, polyvinylidene chlorides, polysulfones, or combinations thereof. The core of the expandable may contain hydrocarbons, including but not limited to isobutane, isopentane, or other suitable blowing agents, which vaporize when heated, leading to particle expansion, which in turn increases the thickness and reduces the density of the spacer containing expandable particles.

Alternatively, the foamable materials, upon exposure to external stimuli, lead to foam generation through either physical foam generation or chemical foam generation. In the context used herein, “physical foam generation” refers to a process that involves injecting a gas into a liquid or polymer melt to create a foam due to a change in temperature, pressure, or other physical factors. The material's chemical composition remains the same. In the context used herein “chemical foam generation” refers to a chemical reaction generating gas, which in turn creates foam. The chemical reaction is initiated due to a change in temperature, pressure, or other physical factors. This change creates new substances with different chemical and physical properties. The foamable materials may include but are not limited to blowing agents, foaming agents, a two-component foaming material, surfactants, catalysts, photoacids generators, phase-changing material or any combination thereof. The foam generation leads to expansion of the spacer, resulting in increased thickness and reduced density.

In one embodiment, the spacer may include a particle or layer having a breakable protective layer separating an acid component and a base component. The breakable protective layer may be a silica material, wax, paraffin, or triglycerides that may be ruptured upon application of a force. This causes a rupturing of the contents which may be an organic acid, base or water, that interacts with other components in the polymer matrix to cause expansion. Suitable organic acids may include, but are not limited to, formic acid, acetic acid, propionic acid, butyric acid, lactic acid, malic acid, citric acid, tartaric acid, oxalic acid, succinic acid, glutaric acid, glycolic acid, and ascorbic acid. Suitable bases may include, but are not limited to, sodium bicarbonate, potassium bicarbonate, and calcium carbonate.

The increase in thickness of the spacer, either through expansion or foam generation, creates separation between the RFID device and the high dielectric and conductive environment. This separation, which may range from a less than a millimeter to several centimeters depending on the degree of expansion or foam generation, helps to reduce interference from high dielectric and conductive environments that might otherwise impair the performance of the RFID device.

The environmentally adaptable RFID device may also incorporate one or more activatable isolating layers that can change their physical dimensions post-application. These isolating layers may be activated by thermal, ultraviolet, or mechanical force. The activation may cause the isolating layers to expand in one or more dimensions, potentially improving the separation between the antenna structure and the surrounding high-dielectric materials.

The above-disclosed impedance-matching mechanisms may work together or independently to help the environmentally adaptable RFID device maintain desirable levels of performance across a range of dielectric environments. In some cases, the environmentally adaptable RFID device may achieve environmental adaptability through the interaction of various elements, either alone or in any combination. The antenna structure, impedance-matching mechanisms, and adaptive radiation patterns may work together to optimize performance in different environments.

### EXAMPLES

The following examples are provided solely to illustrate the present invention and are not intended to limit the scope of the invention, described herein.

### Examples 1-87

Various antenna designs with the parameters specified in Table 1 for folded dipole antennas were built and tested using simulation software, Ansys HFSS. The RFID devices were placed on a label and attached in the center of a package having a foam tray containing chicken wrapped in a polyamide film. Another package of meat was placed above the RFID device tested as demonstrated in FIG. 3C. The model used to test the total efficiency and radiation efficiency. The foam tray had a thickness of 4.5 mm and a relative permittivity εr=1.1, loss δ=0.046. The polyamide film had a thickness of 0.02 mm and a relative permittivity εr=4.3, loss δ=0.004. The chicken had a dimension of 380 mm×225 mm with a thickness of 40 mm. The relative permittivity of the chicken was εr=56.8, loss δ=0.38.

The parameters are reported in Table 1 for each RFID device tested. Examples 1 to 87 demonstrate improved performance over the comparative examples A-Z. The total efficiency % and IC impedance matching efficiency (tau) at 902 to 928 MHz are reported in Table 1.

TABLE 1
Inventive Examples

| | Antenna | Loop | No. of | | | | |
|---|---|---|---|---|---|---|---|
| | Width | Length | Vertical | Aspect | Perimeter | Total | Matching |
| Example | (mm) | (mm) | sections | Ratio | (mm) | Eff. % | Eff. (tau) |
| 1 | 59.05 | 45.05 | 3.2 | 2.59 | 225.11 | 0.14 | 0.63 |
| 2 | 57.76 | 44.96 | 3.2 | 2.57 | 221.77 | 0.13 | 0.60 |
| 3 | 65.77 | 49.42 | 1.2 | 3.20 | 181.28 | 0.12 | 0.67 |
| 4 | 52.13 | 45.97 | 3.0 | 2.38 | 208.01 | 0.12 | 0.58 |
| 5 | 69.78 | 48.55 | 1.4 | 3.31 | 193.53 | 0.12 | 0.60 |
| 6 | 51.88 | 47.28 | 3.2 | 2.35 | 216.19 | 0.12 | 0.64 |
| 7 | 51.03 | 47.35 | 3.2 | 2.30 | 215.01 | 0.12 | 0.63 |
| 8 | 53.22 | 46.13 | 2.8 | 2.40 | 206.50 | 0.12 | 0.58 |
| 9 | 52.66 | 47.03 | 3.5 | 2.43 | 221.91 | 0.12 | 0.65 |
| 10 | 50.67 | 46.79 | 3.3 | 2.20 | 227.81 | 0.12 | 0.64 |
| 11 | 52.64 | 46.06 | 2.8 | 2.40 | 205.46 | 0.12 | 0.58 |
| 12 | 51.26 | 46.67 | 3.3 | 2.37 | 221.53 | 0.12 | 0.63 |
| 13 | 54.65 | 46.32 | 2.7 | 2.44 | 206.86 | 0.12 | 0.57 |
| 14 | 65.87 | 49.46 | 1.1 | 3.03 | 177.40 | 0.12 | 0.66 |
| 15 | 51.21 | 46.28 | 3.4 | 2.36 | 225.65 | 0.12 | 0.63 |
| 16 | 51.62 | 46.85 | 2.7 | 2.25 | 207.00 | 0.12 | 0.59 |
| 17 | 50.42 | 47.14 | 2.9 | 2.17 | 211.40 | 0.12 | 0.60 |
| 18 | 53.29 | 45.58 | 3.5 | 2.61 | 214.59 | 0.12 | 0.63 |
| 19 | 50.71 | 46.53 | 3.3 | 2.34 | 220.77 | 0.12 | 0.63 |
| 20 | 51.44 | 45.97 | 3.1 | 2.37 | 206.80 | 0.12 | 0.58 |
| 21 | 53.01 | 46.57 | 3.3 | 2.52 | 220.88 | 0.12 | 0.63 |
| 22 | 50.75 | 46.20 | 3.2 | 2.33 | 221.50 | 0.12 | 0.61 |
| 23 | 50.33 | 46.67 | 3.5 | 2.21 | 231.78 | 0.12 | 0.63 |
| 24 | 51.66 | 48.44 | 1.1 | 1.53 | 208.80 | 0.12 | 0.66 |
| 25 | 54.89 | 46.43 | 2.7 | 2.46 | 206.79 | 0.12 | 0.55 |
| 26 | 66.84 | 49.25 | 1.3 | 3.34 | 181.07 | 0.11 | 0.55 |
| 27 | 65.10 | 49.53 | 1.1 | 2.99 | 173.27 | 0.11 | 0.67 |
| 28 | 64.24 | 49.42 | 1.3 | 3.21 | 176.06 | 0.11 | 0.56 |
| 29 | 53.13 | 46.51 | 3.8 | 2.51 | 224.32 | 0.11 | 0.64 |
| 30 | 51.66 | 48.44 | 1.2 | 1.51 | 213.62 | 0.11 | 0.68 |
| 31 | 50.48 | 48.18 | 1.1 | 1.47 | 207.72 | 0.11 | 0.68 |
| 32 | 56.08 | 46.46 | 2.6 | 2.50 | 208.25 | 0.11 | 0.54 |
| 33 | 53.17 | 46.21 | 3.7 | 2.53 | 238.20 | 0.11 | 0.66 |
| 34 | 68.59 | 49.76 | 1.1 | 3.15 | 179.57 | 0.11 | 0.65 |
| 35 | 49.72 | 46.11 | 3.4 | 2.21 | 215.07 | 0.11 | 0.65 |
| 36 | 49.72 | 46.11 | 3.4 | 2.23 | 234.05 | 0.11 | 0.66 |
| 37 | 50.79 | 49.35 | 1.2 | 1.65 | 198.34 | 0.11 | 0.58 |
| 38 | 51.81 | 47.19 | 2.5 | 2.25 | 202.41 | 0.11 | 0.56 |
| 39 | 50.50 | 45.97 | 3.2 | 2.33 | 219.29 | 0.11 | 0.58 |
| 40 | 50.34 | 45.97 | 3.2 | 2.34 | 206.94 | 0.11 | 0.56 |
| 41 | 52.62 | 47.34 | 2.6 | 2.34 | 202.45 | 0.11 | 0.55 |
| 42 | 52.62 | 47.17 | 2.5 | 2.34 | 201.60 | 0.11 | 0.54 |
| 43 | 66.84 | 48.92 | 1.3 | 3.33 | 181.57 | 0.11 | 0.52 |
| 44 | 68.91 | 49.69 | 1.1 | 3.17 | 180.71 | 0.11 | 0.66 |
| 45 | 50.69 | 46.18 | 3.1 | 2.18 | 222.59 | 0.11 | 0.56 |
| 46 | 59.49 | 45.08 | 2.8 | 2.64 | 214.90 | 0.11 | 0.52 |
| 47 | 63.48 | 49.72 | 1.4 | 3.17 | 174.63 | 0.11 | 0.53 |
| 48 | 53.50 | 46.96 | 2.8 | 2.61 | 203.59 | 0.11 | 0.59 |
| 49 | 50.23 | 46.90 | 2.8 | 2.13 | 220.12 | 0.11 | 0.57 |
| 50 | 63.95 | 49.42 | 1.4 | 3.20 | 176.17 | 0.11 | 0.53 |
| 51 | 50.48 | 45.84 | 3.1 | 2.35 | 222.40 | 0.11 | 0.56 |
| 52 | 53.01 | 45.87 | 4.0 | 2.51 | 247.45 | 0.11 | 0.66 |
| 53 | 50.40 | 45.86 | 3.3 | 2.34 | 228.52 | 0.11 | 0.57 |
| 54 | 49.47 | 47.01 | 2.9 | 2.05 | 226.59 | 0.11 | 0.57 |
| 55 | 53.77 | 46.83 | 2.7 | 2.66 | 199.43 | 0.11 | 0.57 |
| 56 | 50.23 | 46.73 | 2.8 | 2.24 | 213.55 | 0.11 | 0.57 |
| 57 | 67.12 | 41.96 | 3.5 | 2.91 | 280.71 | 0.11 | 0.66 |
| 58 | 49.79 | 46.54 | 2.6 | 2.28 | 206.70 | 0.11 | 0.56 |
| 59 | 50.50 | 45.89 | 2.9 | 2.35 | 215.98 | 0.10 | 0.56 |
| 60 | 54.55 | 48.08 | 2.8 | 2.45 | 209.62 | 0.10 | 0.53 |
| 61 | 57.48 | 45.22 | 2.3 | 2.56 | 198.74 | 0.10 | 0.57 |
| 62 | 47.25 | 45.87 | 2.4 | 1.72 | 208.87 | 0.10 | 0.58 |
| 63 | 49.92 | 45.96 | 2.7 | 2.04 | 219.20 | 0.10 | 0.56 |
| 64 | 50.54 | 48.61 | 3.7 | 2.33 | 239.27 | 0.10 | 0.60 |
| 65 | 50.55 | 45.57 | 4.4 | 2.21 | 271.71 | 0.10 | 0.71 |
| 66 | 50.50 | 45.46 | 3.1 | 2.33 | 216.29 | 0.10 | 0.53 |
| 67 | 54.60 | 47.92 | 2.7 | 2.45 | 206.46 | 0.10 | 0.51 |
| 68 | 53.82 | 46.98 | 2.5 | 2.67 | 193.47 | 0.10 | 0.55 |
| 69 | 42.53 | 44.03 | 5.1 | 2.12 | 281.99 | 0.10 | 0.81 |
| 70 | 50.23 | 46.64 | 2.8 | 2.42 | 204.65 | 0.10 | 0.54 |
| 71 | 48.15 | 45.70 | 2.5 | 1.81 | 224.99 | 0.10 | 0.65 |
| 72 | 58.15 | 45.36 | 2.1 | 2.78 | 189.68 | 0.10 | 0.57 |
| 73 | 41.65 | 43.93 | 2.2 | 1.39 | 206.76 | 0.10 | 0.72 |
| 74 | 44.08 | 50.28 | 3.5 | 1.80 | 234.64 | 0.10 | 0.55 |
| 75 | 54.07 | 46.87 | 2.1 | 2.69 | 185.70 | 0.10 | 0.54 |
| 76 | 48.76 | 48.71 | 3.0 | 2.31 | 207.46 | 0.10 | 0.54 |
| 77 | 50.48 | 45.94 | 2.5 | 2.36 | 203.69 | 0.10 | 0.52 |
| 78 | 57.45 | 43.80 | 4.1 | 2.83 | 242.72 | 0.09 | 0.55 |
| 79 | 55.65 | 48.04 | 2.6 | 2.59 | 204.97 | 0.09 | 0.48 |
| 80 | 45.33 | 50.70 | 2.7 | 1.97 | 168.76 | 0.09 | 0.60 |
| 81 | 54.05 | 43.77 | 4.7 | 2.32 | 275.98 | 0.09 | 0.72 |
| 82 | 49.88 | 45.14 | 3.0 | 2.35 | 211.21 | 0.09 | 0.48 |
| 83 | 41.28 | 54.90 | 2.6 | 1.57 | 209.67 | 0.09 | 0.60 |
| 84 | 49.54 | 45.38 | 2.7 | 2.02 | 217.08 | 0.09 | 0.49 |
| 85 | 52.09 | 44.07 | 3.4 | 2.51 | 203.23 | 0.09 | 0.46 |
| 86 | 47.35 | 48.80 | 2.2 | 2.13 | 192.88 | 0.09 | 0.53 |
| 87 | 51.12 | 46.84 | 2.5 | 2.38 | 202.30 | 0.09 | 0.50 |

Several comparative examples were built using the same model and tested under similar conditions. As shown in Table 2, each of the comparative examples had poor performance resulting from one of the parameters being outside of the inventive range.

TABLE 2
Comparative Examples

| | Antenna | Loop | No. of | | | | |
|---|---|---|---|---|---|---|---|
| Comp. | Width | Length | Vertical | Aspect | Perimeter | Total | Matching |
| Example | (mm) | (mm) | sections | Ratio | (mm) | Eff. % | Eff. (tau) |
| A | 40.30 | 42.88 | 4.2 | 1.05 | 399.53 | 0.01 | 0.15 |
| B | 40.15 | 51.78 | 3.1 | 1.06 | 283.02 | 0.01 | 0.12 |
| C | 53.15 | 55.73 | 3.0 | 2.61 | 231.41 | 0.01 | 0.06 |
| D | 63.35 | 55.83 | 3.4 | 2.92 | 265.09 | 0.01 | 0.06 |
| E | 42.75 | 57.60 | 4.0 | 1.35 | 265.91 | 0.01 | 0.07 |
| F | 49.45 | 57.00 | 3.3 | 1.89 | 227.52 | 0.01 | 0.06 |
| G | 60.95 | 56.30 | 3.2 | 2.40 | 267.87 | 0.01 | 0.07 |
| H | 66.25 | 58.13 | 2.5 | 2.01 | 321.61 | 0.01 | 0.11 |
| I | 46.65 | 57.80 | 4.3 | 1.93 | 285.72 | 0.01 | 0.06 |
| J | 59.95 | 58.97 | 3.1 | 2.54 | 262.10 | 0.01 | 0.06 |
| K | 68.75 | 57.57 | 5.5 | 2.67 | 370.59 | 0.01 | 0.10 |
| L | 61.53 | 58.02 | 3.9 | 2.95 | 255.83 | 0.01 | 0.06 |
| M | 52.62 | 57.62 | 3.8 | 1.37 | 330.47 | 0.01 | 0.13 |
| N | 65.69 | 57.23 | 3.4 | 2.64 | 277.52 | 0.01 | 0.07 |
| O | 42.82 | 59.31 | 3.5 | 1.53 | 262.68 | 0.01 | 0.05 |
| P | 48.85 | 54.30 | 5.2 | 1.23 | 441.66 | 0.01 | 0.18 |
| Q | 41.15 | 53.57 | 2.7 | 1.19 | 281.00 | 0.01 | 0.11 |
| R | 41.85 | 52.37 | 4.7 | 1.23 | 330.78 | 0.01 | 0.14 |
| S | 44.27 | 41.99 | 5.7 | 1.16 | 446.33 | 0.01 | 0.13 |
| T | 41.34 | 51.39 | 5.9 | 1.24 | 381.79 | 0.01 | 0.13 |
| U | 46.35 | 50.67 | 2.6 | 1.31 | 286.20 | 0.01 | 0.16 |
| V | 66.35 | 53.00 | 4.7 | 1.81 | 447.43 | 0.01 | 0.15 |
| W | 69.05 | 54.43 | 4.7 | 2.25 | 424.53 | 0.01 | 0.16 |
| X | 63.05 | 53.30 | 4.1 | 1.69 | 400.80 | 0.01 | 0.12 |
| Y | 55.40 | 41.37 | 5.6 | 1.43 | 417.68 | 0.01 | 0.18 |
| Z | 49.95 | 54.55 | 5.7 | 2.15 | 340.26 | 0.01 | 0.08 |

The antenna width for comparative examples A and B was less than 41 mm, which contributed to the poor performance. The loop length comparative examples C-O was greater than 55 mm, which contributed to the poor performance. The aspect ratio for comparatives examples A and B, as well as comparative examples P-T were less than 1.3, which contributed to the poor performance. The perimeter for comparative examples U-Z was greater than 271 mm, which contributed to the poor performance.

A number of implementations have been described. Nevertheless, it will be understood that various modifications may be made without departing from the spirit and scope of the disclosure. Accordingly, other implementations are within the scope of the following claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such a term is intended to be inclusive in a manner similar to the term “comprising” as “comprising” is interpreted when employed as a transitional word in a claim.

What is claimed is:

1. A RFID antenna comprising:
a loop segment having pads at each end configured to connect to an integrated circuit chip; and
one or more emission segments, each emission segment comprising a connection portion, folded portion, a longitudinal edge portion, and a line portion, where the line portions of each emission segments are joined, to define a perimeter of the RFID antenna, wherein
the antenna width ranges from 41 mm to 70 mm,
the loop length of the loop segment ranges from 41 mm to 55 mm,
an aspect ratio of the RFID antenna ranges from 1.3 to 3.4, and
the perimeter ranges from 168 mm to 282 mm;
wherein the RFID antenna has a total efficiency of at least 0.09% or more and IC impedance matching efficiency of at least 0.45 or more.

2. The RFID antenna of claim 1, wherein the one or more emission segments are a conductive trace having a width ranging from 0.3 mm to 3 mm.

3. The RFID antenna of claim 1, wherein the width of a conductive trace forming the longitudinal edge portion is equal to or less than the width of a conductive trace forming the folded portion.

4. The RFID antenna of claim 1, wherein the folded portion has at least one vertical segment.

5. The RFID antenna of claim 1, wherein the line portion is non-meandering.

6. The RFID antenna of claim 1, wherein the antenna width ranging from 47 mm to 57 mm.

7. The RFID antenna of claim 1, wherein the loop length of the loop segment ranges from 45 mm to 50 mm.

8. The RFID antenna of claim 1, wherein an aspect ratio of the RFID antenna ranges from 2.5 to 3.2.

9. The RFID antenna of claim 1, wherein the perimeter ranges from 190 mm to 230 mm.

10. A RFID device comprising:
a RFID integrated circuit chip; and
an antenna comprising:
a loop segment having pads at each end configured to connect to an integrated circuit chip; and
one or more emission segments, each emission segment comprising a connection portion, folded portion, a longitudinal edge portion, and a line portion, where the line portions of each emission segments are joined, to define a perimeter of the RFID antenna, wherein
the antenna width ranges from 41 mm to 70 mm,
the loop length of the loop segment ranges from 41 mm to 55 mm,
an aspect ratio of the RFID antenna ranges from 1.3 to 3.4, and
the perimeter ranges from 168 mm to 282 mm;
wherein the RFID antenna has a total efficiency of at least 0.09% or more and IC impedance matching efficiency of at least 0.45 or more.

11. The RFID device of claim 10, wherein the RFID device is applied to a label having at least one adhesive surface.

12. The RFID device of claim 10, wherein the label is applied to a package containing a high-dielectric material.

13. The RFID device of claim 10, wherein high-dielectric material has a relative permittivity from 10 to 60.

14. The RFID device of claim 10, wherein the RFID device is applied to a package containing a high-dielectric material.

15. The RFID device of claim 10, wherein the read rate of the RFID device is greater than or equal to 75%.
